(19) United States
(12) Patent Application Publication
(10) Pub. No.: US 2018/0022651 A1
(43) Pub. Date: Jan. 25, 2018

(54) Neutron Absorbing Composite Material and Method of Manufacture

(71) Applicant: Richard Adams, Bolton, MA (US)

(72) Inventor: Richard Adams, Bolton, MA (US)

(21) Appl. No.: 15/650,855

(22) Filed: Jul. 15, 2017

Related U.S. Application Data
(60) Provisional application No. 62/493,880, filed on Jul. 19, 2016.

(51) Int. Cl. C04B 35/563; C04B 35/657; C04B 35/628; G21F 1/10; C04B 41/48; C04B 41/50; C04B 41/00; C04B 35/626; C04B 37/00

(52) U.S. Cl. CPC C04B 35/563; C04B 35/62695; C04B 35/657; C04B 35/62842; C04B 37/006; C04B 41/4803; C04B 41/50; C04B 41/009; G21F 1/106; C04B 2235/3821; C04B 2235/402; C04B 2235/5436; C04B 2235/604; C04B 2235/616; C04B 2235/602; C04B 2235/77; C04B 2235/96; C04B 2237/121; C04B 2237/36; C04B 2237/60

(57) ABSTRACT

A method of producing a neutron absorbing plate constructed of a boron carbide aluminum matrix composite material is disclosed. The method includes mixing a 30-50 micron average particle size B4C powder with an aqueous organic binder component to form a slurry; then drying the slurry at a temperature from about 20 to about 90 degrees Celsius until a dried cake comprising 1-20 percent organic binder of the total weight of said dry cake is formed; then granulating said dried cake to yield a granule size from about 0.5 mm to about 3 mm; then compressing said granules under pressure to create a particulate preform having an interior open porosity; and finally infiltrating the preform under pressure with a liquid metal, to form a metal matrix composite with uniform B4C particle loading.

### CROSS-REFERENCE TO RELATED APPLICATIONS

The present application is related to, claims the earliest available effective filing date(s) from (e.g., claims earliest available priority dates for other than provisional patent applications; claims benefits under 35 USC §119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith:

U.S. provisional patent application 62/493,880 entitled “NEUTRON ABSORBING COMPOSITE MATERIAL AND METHOD OF MANUFACTURE”, naming Richard Adams as inventor, filed Jul. 19, 2016.

### FIELD OF THE INVENTION

This invention relates to a neutron-absorbing composite material and its production process.

### BACKGROUND OF THE INVENTION

A fuel storage facility provides for on-site storage of both new and spent fuel assemblies at nuclear power plants. The fuel storage facility includes a fuel pit or pool which is a reinforced concrete structure with a stainless steel liner, filled with borated reactor makeup water. Fuel storage containers or cans of square cross-section and standing uptight in a spaced side-by-side array are provided under water in the fuel pool. The cans are designed to accommodate a large number of fuel assemblies, for example 850, at predetermined locations such that the fuel assemblies are maintained in a sub-critical array in the fuel pool.

Neutron absorbers or poisons, such as boron carbide, in slab-like form are typically mounted in narrow pockets extending vertically along the sides of the cans, with the makeup water filling remainder of the space between the cans, to assist in maintaining the fuel in a condition of sub criticality. Fast neutrons are emitted by the fuel and therefore it is desirable to be able to slow them so that they can be absorbed more effectively in the absorber material. The slabs of boron carbide and volume of borated makeup water between them serve as a flux trap neutron absorber arrangement in the storage pool between the stored fuel assemblies. The water provides a fast neutron slow-down region with the surrounding boron carbide, in the slab or plate form, providing a thermal neutron absorber. The fast neutrons enter into the water contained in the slow-down region between the boron carbide plates of thermal neutron absorber. The hydrogen atoms in the water slow the fast neutrons down between the plates so that they can be absorbed by the thermal neutron absorber of the plates.

A plurality of such flux trap neutron absorber arrangements are located between the cans containing the fuel assemblies to assist in maintaining the fuel assembly array in a safe shutdown subcritical condition. Because the pool space is fixed at the nuclear power plants and the demand for more and higher enrichment fuel storage is becoming critical, there is a need for maximizing the amount of fuel that can be stored there. As a result the minimization of the storage cell structural volume in the pool is important. Dimensional changes as small as 0.1 inch are critical to the designer, in meeting the sub-requirements, maximizing the storage capacity, and minimizing material requirements.

Consequently, there is a need to produce slabs of born carbide neutron absorbers more efficiently, with better structural integrity, and with high B4C content even at minimal thicknesses. Boron, because of its relative cheapness and abundance compared with other materials having high thermal neutron absorption properties, has been used extensively in the aforementioned nuclear reactor applications for the control of neutron absorption. Boron, on neutron capture, fissions to produce isotopes of lithium and helium namely Li′ and He, the nuclei of both of which have low neutron absorption properties. Boron can therefore be used as a burnable poison in a reactor. When boron and solid high temperature boron compounds are used for control rods, they are usually contained in a sheath which provides the necessary resistance to mechanical and thermal shock. Alloys of boron have also been used in reactors but boron and boron compounds form brittle compounds with most metals of interest, such as iron, nickel, zirconium, titanium and chromium. As a result only small amounts of boron can be incorporated, for example less than 4% by weight.

A similar difficulty would arise if particles of boron or boron compounds were to be dispersed in a metal matrix by powder metallurgy techniques since some reaction would take place at sintering and fabricating temperatures. The methods of the present invention eliminates the drawbacks of conventional powder metallurgy approach. Powder Metallurgy requires fabrication of a billet of Al+B4C powders, then costly hot pressing or hot isostatic pressing (or extrusion of a semi-solid Al+B4C mix), followed by costly rolling of billet stock into sheet stock. This approach is very capital intensive, requires large batch sizes, and the quality of the microstructure is often characterized by residual internal porosity. Stir casting followed by extrusion is also a capital intensive method of fabrication of Al+B4C plates, and neither powder metallurgy nor stir casting methods are amenable to include fiber reinforcement as in the present invention.

The methods of the present invention utilize direct liquid metal infiltration of a powder body to a final shape and has the distinct advantage of producing a highly absorbent neutron absorber having high concentrations of B4C that may include ceramic fiber reinforcement. Conventional processing yields B4C powder concentrations less than about 40% and the methods of the present invention could readily yield 50-70% particulate loading with very high temperature creep and fire barrier properties when fiber reinforcements are utilized in combination with the particulate body in a metal matrix composite. This is accomplished utilizing B4C particles or mixtures of B4C particles with other particulate types, such as, but not limited to Al2O3, SiC, and metal powders then cladding such particulate body with ceramic fibers where the structure is then incorporated in the metal matrix.

### SUMMARY OF THE INVENTION

The present invention relates to a method of producing a neutron absorbing plate constructed of a boron carbide aluminum matrix composite material. Metal matrix composites have excellent tensile strength and stiffness and high thermal conductivity. Some Metal matrix composites (MMICs) are made by placing porous preforms into a mold cavity and infiltrating with aluminum. Ceramic fiber reinforced metal matrix composites (MMC) are being explored as lightweight alternatives to traditional structural metals.

A boron carbide aluminum matrix composite plate comprises a sufficient amount of boron carbide to effectively absorb neutron radiation emitted from a spent fuel assembly and thereby shield adjacent spent fuel assemblies in a fuel rack from one another. In one embodiment, the plate is constructed of an aluminum boron carbide metal matrix composite material that is 25% to 70% by volume boron carbide. Of course, the invention is not so limited and other percentages and mixtures of particles may be utilized. The exact percentage of neutron absorbing particulate reinforcement required to be in the metal matrix composite material will depend on a number of factors, including the thickness (i.e., gauge) of the insert, the spacing between adjacent cells within the fuel rack, and the radiation levels of the spent fuel assemblies. Other metal matrix composites having neutron absorbing particulate reinforcementare within the scope of the present invention.

In the present invention, the neutron absorbing plates are formed through molten metal infiltration casting which enables the production of plates of varying thicknesses and dimensions as defined by the mold cavity, thus eliminating the need for costly thickness reduction rolling processes. Since casting into a preform structure to net-shape, the structure can also include additional inserts stacked into the mold cavity to form the final plate structure. The inserts can be in the form of ceramic fiber fabrics or papers, or in the form of neat aluminum foils or plates, or ceramic tiles. Also, the plate structures, after casting to net-shape, can be as thin as 0.060″ or less. Since the plates can be net-shape cast into a variety of shapes and thicknesses the invention can be used in any environment and/or used to create a wide variety of structures, including without limitation fuel baskets, fuel racks, sleeves, fuels tubes, housing structures, etc.

It should be pointed out that part of the novelty of this technology is the flex-ability of the process to manufacture plates to meet manufacturer fuel storage requirements. It appears from initial fabrications that the process is very scalable and is capable of meeting all known spent fuel storage applications.

### DETAILED DESCRIPTION OF THE INVENTION

A method of producing a neutron absorbing plate to be utilized standalone or in a pre-fabricated assembly is described herein. It is understood that the inventive neutron absorbing plate can be used in any environment (and in conjunction with any other equipment) where neutron absorption is desirable and compatible with aluminum metal matrix composites.

As space concerns within the fuel pond increase, it has become desirable that the neutron absorbing plate take up as little room as possible in the cell of the fuel rack. Thus, the Plate is preferably constructed of an aluminum boron carbide metal matrix composite material having a percentage of boron carbide between 25% and 70%. The method of the present invention, as described below, has mad it possible to fabricate sheets of boron carbide aluminum matrix composite material to a variety of Net-Shapes and thicknesses to meet end user requirements.

The method of the present invention begins with the production of a Metal Matrix Composite (MMC) of B4C and aluminum. The method of producing such a composite involves creating a preform suitable for molten metal infiltration, the preform including a B4C powder, or mixture of B4C with other powders, that is mixed with a binder component. In one embodiment of the present method, an average particle size of between 30-50 microns B4C powder can be utilized or alternatively a bi-modal distribution including both 30-50 micron average particle sizes and an average 1-5 micron particle size B4C powder. A bi-modal distribution will help to control powder packing and the ultimate powder fraction present in the final composite. Other powders may be mixed with the B4C powder to further control total B4C content. Such ceramic powders include but are not limited to alumina, SiC, and a variety of other oxide, nitride, and carbide ceramic powders. Metal powders, such as stainless steel, tungsten, may also be utilized in the B4C powder mixture .

A typical ceramic processing aqueous binder component to be added to the B4C powder is next prepared, and comprises at a minimum both a binder and a surfactant. The binder is present to provide adhesive bond between the B4C particles, providing green body structure and strength to the particulate body. The dispersant is present to help uniformly distribute the powder into individual particles that remain separate and suspended in the aqueous media during drying.

The binder and B4C powder are mixed to produce a low viscosity slurry with a solids content from about 30 to about 50%. The slurry is then ambient air or hot oven dried at a temperature of about 20 to about 80 degrees Celsius for several hours until a dried cake is created, with softness and flexibility imparted by the organic binder constituents.

Drying times vary depending on the volume of slurry mixture to be dried. In the preferred embodiment, and after drying the binder component is 1-20% the total weight of the resultant preform with the B4C being 80-95 percent by weight.

After drying, the resultant “cake” is granulated and passed through metal sieves to yield a granule size of about 0.5 mm to 3 mm. Alternative methods of granulating the slurry include spray drying the slurry directly to form granules or mixing the slurry to create a dry mix prior to milling through the metal sieves. Granule size of about 0.5 mm-3 mm allow leveling in a mold cavity and compression under relatively low pressure of between 10-50 psi to form a particulate preform directly within the casting mold. The compression may be accomplished by utilizing the lid of the mold cavity or any external workpiece for exerting force and compressing the preform. The granules compress in the resultant preform from about 20 to about 50 percent of the original volume of the granulated cake, and are compressed within the mold cavity to conform to the dimensions of the mold. Alternatively, a particulate preform may be formed outside of the mold cavity then placed within the mold.

In an alternative embodiment, the resultant slurry can be poured into a flat plate mold comprised of an aluminum ring frame placed atop an aluminum plate or other suitable substrate. The mold is vibrated or tapped to completely fill the frame with the slurry. The frame/slurry combination is allowed to dry in ambient air, for several hours. After drying the resultant particulate panels (aka preform layers) can be further hardened by heating in air to about 80C-100C.

In yet another alternative embodiment, the resultant slurry is added to a pressurized spray gun, and sprayed direct onto either an Al sheet substrate or fiber paper substrate. Both the Al sheet or fiber paper are placed on a hot plate set for 195F. The slurry is sprayed under pressure until the desired dry powder thickness is achieved.

At this point multiple preform layers may be stacked within the mold if desired to impart structural rigidity to the final plate structure. Each preform layer has a typical thickness of about 0.020 inches to about 0.200, inches however, a wide range of thickness can be achieved. In the example described below the particulate preform has a thickness of 0.085 inches. The presence of the binder helps to keep the particulate preform structure intact during subsequent casting steps without gross particle rearrangement. The resultant B4C preform has an interior open porosity between about 30% and about 75% prior to metal infiltration and has a predetermined fraction of void volume or open structure throughout the material structure. Following infiltration casting the B4C preform becomes metal rich throughout its open porosity. The resultant MMC has a density from about 2.6 to about 3 grams/cubic centimeter.

If combined with fiber reinforcement, then prior to placing the preforms in the mold cavity, a fiber paper sheet of either discontinuous alumina sheets or quartz veil sheets may be placed on the bottom of the mold cavity. The fiber paper may have a nominal thickness of about 0.020 inches. The B4C containing particulate preform is then placed atop the fiber paper. Next, another matching fiber paper sheet having a nominal thickness of about 0.020 inches is placed on top of the preform and the mold is closed. Ceramic fibers may be added between and around the preforms to increase the overall creep and heat resistance and ductility of the resultant MMC plate structure. Examples of such fibers include but are not limited to Saffil fiber paper, nominally about 5% fiber volume of short, discontinuous alumina fiber, or fabrics woven from continuous ceramic fiber, such as 3M Nextel, achieving about 30% fiber loading by volume. Quartz, and glass fiber use can also be anticipated for this application, whether as continuous or discontinuous fiber structures.

The mold is next infiltrated with aluminum. The aluminum infiltration process causes aluminum to penetrate throughout the overall structure and solidifies within the open porosity of the material layers. In cases where multiple layers are present, the liquid metal extends from one layer to the next, binding the layers together and integrating the structure. While molten aluminum is the embodiment illustrated other suitable metals include but are not limited to aluminum alloys, copper, titanium and magnesium and other metal alloys cast from the molten liquid phase. The liquid metal infiltration process is described in U.S. Pat. No. 3,547,180 and incorporated herein by reference for all that it discloses. Subsequent to the liquid metal infiltration step, the metal matrix composite is next demolded or removed from the closed mold.

In this embodiment, Aluminum infiltration permeates throughout the fiber reinforced surfaces and the B4C particulate core to create a three layer MMC sandwich comprised of about 5% fiber loading MMC skin cladding at 0.020″ thickness with about 50 vol% B4C particulate filled aluminum metal core at 0.085″ or a total thickness of 0.125″. This structure provides sufficient B4C content at this thickness and volume fraction for most neutron absorber applications, and the 95% aluminum reinforced with 5% ceramic fiber skins provide overall ductility to the structure, nominally greater than 1% elongation of the sandwich body and imparts greater high temperature creep resistance.

Alternatively, the fiber paper sheets positioned both on the top and bottom of the preform can be replaced with Al foil sheets at 0.020″ thickness. This structure is then placed in a closed mold and aluminum infiltrated to permeate the preform with aluminum while bonding the aluminum foil sheets to the top and bottom sides of the preform.

We claim:

1. A method of producing a neutron absorbing Metal Matrix Composite, comprising the steps of:
mixing a 30-50 micron average particle size B4C powder with an aqueous organic binder component to form a slurry;
drying said slurry at a temperature from about 20 to about 90 degrees Celsius until a dried cake comprising 1-20 percent organic binder of the total weight of said dry cake is formed;
granulating said dried cake to yield a granule size from about 0.5 mm to about 3 mm;
compressing said granules under pressure to create a particulate preform having an interior open porosity;
infiltrating said preform under pressure with a liquid metal, said metal infiltrating said interior open porosity of said preform to form a metal matrix composite, said metal matrix composite having uniform B4C particle loading.

2. A method of producing a neutron absorbing Metal Matrix Composite as in claim 1, wherein the step of compressing said granules further includes the steps of placing said granules in a mold cavity; then
applying low pressure from about 10 to about 15 PSI to allow said resultant preform to conform to the dimensions of said mold cavity.

3. A method of producing a neutron absorbing Metal Matrix Composite as in claim 1, wherein said preform compresses from about 20 to about 50 percent of its original volume subsequent to said compression step.

4. A method of producing a neutron absorbing Metal Matrix Composite as in claim 1, wherein said mixing step further includes the addition of a 1-5 micron average particle size B4C powder mixed with said 30-50 micron average particle size B4C powder to form a bi-modal distribution of B4C powder.

5. A method of producing a neutron absorbing Metal Matrix Composite as in claim 1, wherein said mixing step continues up to a point where said binder and said B4C form a low viscosity slurry with a solids content between from about 30% to about 50%.

6. A method of producing a neutron absorbing Metal Matrix Composite as in claim 1, wherein said preform has an interior open porosity between about 30% and about 75%, and has a percentage of B4C between about 70% and about 25%.

7. A method of producing a neutron absorbing Metal Matrix Composite as in claim 1, wherein said metal matrix composite has a density from about 2.6 to about 3.0 grams/cubic centimeter.

8. A method of producing a neutron absorbing Metal Matrix Composite as in claim 2, wherein said step of applying low pressure is accomplished with a lid exerting force downward against said preform.

9. A method of producing a neutron absorbing Metal Matrix Composite as in claim 2, further including the step of stacking a plurality of preforms prior to said infiltration step.

10. A method of producing a neutron absorbing Metal Matrix Composite as in claim 2, further including the step of:
placing a layer of fiber paper on the top and bottom of said resultant preform, said fiber paper having an interior porosity of about 95%.

11. A method of producing a neutron absorbing Metal Matrix Composite as in claim 9, wherein said stacking step further includes mixing a plurality of ceramic fibers on top and around said plurality of said preform to increase creep and heat resistance.

12. A method of producing a neutron absorbing metal matrix composite, comprising the steps of:
mixing a 30-50 micron size B4C powder with an aqueous organic binder component to form a slurry;
drying said slurry at a temperature from about 20 to about 90 degrees Celsius until a dried cake comprising 1-20 percent organic binder of the total weight of said dry cake is formed;
granulating said dried cake to yield a granule size from about 0.5 mm to about 3 mm;
compressing said granules under pressure to create a particulate preform having an interior open porosity.

13. A method of producing a neutron absorbing metal matrix composite as in claim 12, further including the step of:
infiltrating said preform under pressure with a liquid metal, said metal infiltrating said interior open porosity of said preform to form a metal matrix composite, said metal matrix composite having uniform B4C particle loading.

14. A neutron absorbing metal matrix composite, comprising:
at least one stacked preform having an interior porosity between about 30% to about 75%, said preform further comprising between about 25% to about 70% of B4C;
said at least one stacked preform positioned between a top and bottom layer of fiber paper, said fiber paper having an interior porosity of about 95%;
said at least one stacked preform and said top and bottom layer further comprising a metal, said metal infiltrated within said stacked preform interior open porosity and said top and bottom fiber paper layers interior open porosity, said metal infiltration forming a neutron absorbing metal matrix composite;
wherein said metal matrix composite comprises about 5% fiber loading and a ductility greater than 1%, and wherein said B4C is distributed uniformly throughout the entire volume of said metal matrix composite.

15. A neutron absorbing metal matrix composite as in claim 14, wherein said preform is between about 0.020 to about 0.2 inches in thickness and said top and bottom fiber paper layers are each about 0.020-0.040 inches in thickness.

16. A neutron absorbing metal matrix composite as in claim 14, wherein said neutron absorbing metal matrix composite has a density of 2.6 to about 3.0 grams/cubic centimeter.

17. (canceled)

18. A method of producing a neutron absorbing Metal Matrix Composite as in claim 2, wherein said slurry is placed into said mold cavity prior to said drying step.

19. A method of producing a neutron absorbing Metal Matrix Composite as in claim 1, wherein said mixing step further includes the steps of:
Mixing ceramic powders with said 30-50 micron size B4C powder up to a point where particulate loading is about 50 percent, said powders selected from the group consisting of alumina, SiC, oxide, nitride, and carbide.
